(19) United States
(12) Patent Application Publication
(10) Pub. No.: US 2026/0230901 A1
(43) Pub. Date: Aug. 6, 2026

(54) OUT OF BAND APPLICATION PROGRAMMING INTERFACE FOR PROVIDING A UE MAXIMUM BIT RATE

(71) Applicant: Verizon Patent and Licensing Inc., Basking Ridge, NJ (US)

(72) Inventors: Syed Rehman, Monmouth Junction, NJ (US); Khurram Abbas, Novi, MI (US); Sanjay Mishra, North Potomac, MD (US); Raymond Wai-Man So, San Ramon, CA (US); Raghuram Parvataneni, Frisco, TX (US)

(21) Appl. No.: 19/046,587

(22) Filed: Feb. 6, 2025

(51) Int. Cl. H04W 28/02; H04W 28/24; H04W 36/14

(52) U.S. Cl. CPC H04W 28/0257; H04W 28/24; H04W 36/144

(57) ABSTRACT

A network device receives from a client application executing at a user equipment device (UE), a notification. The network device obtains, based on the notification, a subscription plan associated with the UE, and determines a Radio Access Technology (RAT) of a mobile network that is currently serving the UE. The network device identifies a maximum bit rate for the client application based on the subscription plan and the determined RAT. The network device sends the identified maximum bit rate to the client application for use in limiting a bit rate of one or more data sessions involving the client application that transit the mobile network.

### BACKGROUND

A content delivery network (CDN) includes a large distributed system of servers deployed in multiple data centers across the Internet. A CDN serves content, including different types of media, to end users with a high level of performance. The content may include, for example, web objects (text, graphics and/or scripts), downloadable objects (images, audio media, video media, software, and/or documents), applications, and live streaming media (e.g., Hypertext Transfer Protocol (HTTP) Live Streaming (HLS) media, Dynamic Adaptive Streaming over HTTP (DASH)). CDN nodes are typically deployed in multiple locations, often over multiple backbones. The benefits of a CDN include reduction of bandwidth costs, improving web page load times, and increasing the availability of content.

### BRIEF DESCRIPTION OF THE DRAWINGS

FIG. 1 depicts an example network environment in which a mobile network Application Programming Interface (API) Gateway may be implemented to send maximum bit rates to user equipment devices (UEs) as “out of band” communications before a streaming session begins;

FIG. 2 depicts an example of a mobile network and its various interconnections with other nodes, devices, or networks;

FIG. 3 is a diagram that depicts example components of a network device, as referred to herein;

FIG. 4 is a flow diagram of an example process for registering a CDN application server with a mobile network API Gateway;

FIG. 6 is a flow diagram of an example process for specifying a maximum bit rate, to be issued to a client application at a UE, for subsequent use in a media streaming session(s);

FIG. 8 is a flow diagram of an example process for engaging in a streaming session, by a client application with a CDN app server, in which the specified maximum bit rate may be used to limit the bit rate of the streaming session; and

FIGS. 5, 7, and 9 illustrate examples of operations, messages, and data flows associated with processes described herein.

### DETAILED DESCRIPTION

The following detailed description refers to the accompanying drawings. The same reference numbers in different drawings may identify the same or similar elements. The following detailed description does not limit the invention.

HTTP-based media streaming communications protocols, such as HLS or DASH, involve breaking the media stream into a sequence of file downloads. Each file may be downloaded as one portion (or a segment) of a transport stream. Each downloaded file may be played in sequence to present a continuous media stream. As a given stream is played, a client may choose from multiple different alternative streams containing the same content encoded at various data rates. At the beginning of a streaming session, the client downloads a playlist file that specifies the different or alternate streams that are available. In HLS, for example, a given multimedia presentation is specified by a Uniform Resource Identifier (URI) to the playlist file, which itself consists of an ordered list of media URIs and informational tags. Each media URI refers to a media file that is a segment of a single continuous media stream. To play a stream, the client first obtains the playlist file and then obtains and plays each media file in the playlist in sequence.

In mobile networks, client video streaming experiences can be negatively impacted due to a lack of information about a maximum allowed bandwidth for sessions that are streamed over the mobile networks. Without knowing a mobile network's bit rate limitations, client applications, especially those using adaptive bit rate protocols like HLS or DASH, are usually unable to optimize their streams. Mobile network operators often implement media traffic shaping policies, such as video shaping policies, that apply restrictions, including bit rate restrictions, to particular media sessions that transit their mobile network so as to optimize overall network traffic. These video shaping policing mechanisms, when implemented by the mobile network to enforce bandwidth restrictions on sessions, often negatively impact the Quality of Experience (QoE) of the video sessions and add inefficient complexity and overhead. In certain circumstances, such traffic shaping policies may cause high levels of retransmissions of packets involving, for example, video streaming sessions associated with particular servers in CDNs.

To mitigate occurrences of high packet retransmissions over a mobile network for streaming sessions, such as, for example, video streaming sessions, and to also avoid the inefficiencies associated with using video policing mechanisms in the mobile network, implementations described herein provide an API that communicates, as an “out of band” communication from the mobile network, a maximum allowed bit rate to a client application at a UE before a streaming session involving the client application begins. A mobile network API Gateway in the mobile network determines the maximum allowed bit rate for the client application based on, among other possible factors, the UE's subscription plan and the Radio Access Technology (RAT) of the mobile network that is currently serving the UE. The maximum allowed bit rate received by the client application enables the client application to select an appropriate video resolution that aligns with the available bandwidth which, in turn, prevents buffering delays and ensures smooth video playback during the streaming session. Implementation of the mobile network API Gateway, as described herein, also reduces the need for mobile network video shaping policies, simplifying mobile network administration and leading to more efficient use of mobile network resources.

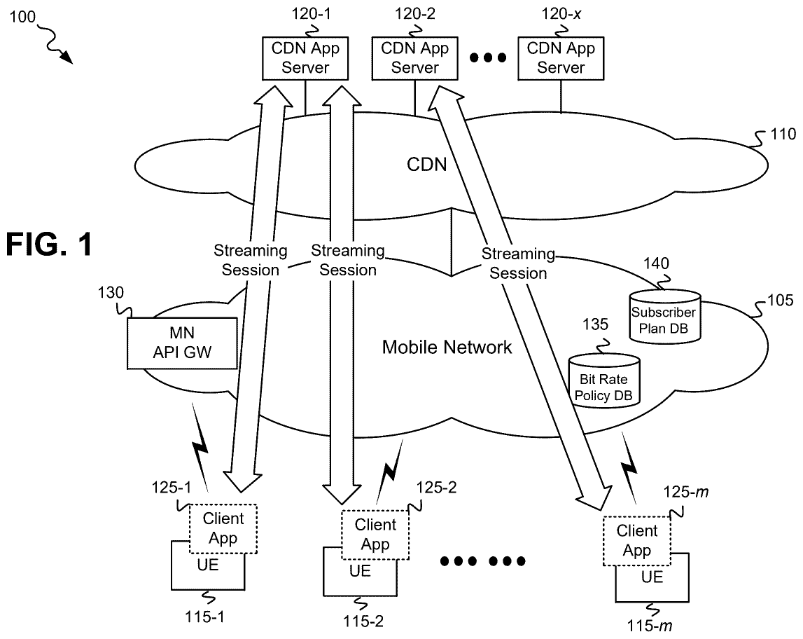

FIG. 1 depicts an example network environment 100 in which a mobile network API Gateway may be implemented to send maximum bit rates to UEs, that engage in a streaming session, as “out of band” communications before a streaming session begins. As shown, network environment 100 may include a mobile network 105, a CDN 110, multiple UEs 115-1 through 115-m, and multiple CDN app servers 120-1 through 120-x.

Mobile network 105 (also referred to herein as “wireless network 105”) may include any type of a Public Land Mobile Network (PLMN). In some implementations, mobile network 105 may include any type of a Next Generation mobile network that may include evolved network components (e.g., future generation components) relative to a Long-Term Evolution (LTE) network, such as a Fourth Generation (4G) or 4.5G LTE mobile network. For example, mobile network 105 may include a Fifth Generation (5G) mobile network. Mobile network 110 may alternatively include an LTE network (e.g., a 4G network), another type of Next Generation network (e.g., a Sixth Generation (6G) mobile network, a 5G Advanced network), or a hybrid mobile network (e.g., a Next Generation/4G hybrid network).

CDN 110 may include one or more interconnected networks, such as, for example, local area networks (LANs), wide area networks (WANs), metropolitan area networks (MANs), telecommunications networks (e.g., Public Switched Telephone Networks (PSTNs)), cable networks (e.g., optical cable networks), Multi-Access Edge Computing networks (MECs), and/or the Internet. Though CDN 110 is shown as a separate network from mobile network 105, CDN 110 may, in some implementations, be a portion, or sub-network, of mobile network 105. In addition to many different types of network nodes (e.g., routers, gateways, switches, etc.), CDN 110 may include (though not shown) one or more web acceleration servers, media storage units, and/or cache memory units.

CDN app servers 120-1 through 120-x (hereinafter “CDN app server 120” or “App server 120”) include network devices that may be located in distributed locations relative to one another, or may be located in one or more groups of servers. As shown, each of CDN app servers 120 may connect to CDN 110 (or to another network, not shown). CDN app servers 120 may each maintain media, and may retrieve and send the media to UEs devices 115 upon request. The media may include, for example, images, audio media, video media, and/or audio/video media. The media may be a component of a web document (e.g., image within the web document), or may be “stand alone” media (e.g., streamed media accessible via “clicking” on a Uniform Resource Locator (URL) within the document). The video or audio/video media may include live streaming media (e.g., HLS or DASH media). CDN 110 may transport the media from CDN app servers 120 to UEs 115 via mobile network 105.

UEs 115-1 through 115-m (referred to herein individually as “UE 115” or collectively as “UEs 115”) may each include any type of electronic device having a wireless communication capability. Network environment 100 may include any number of UEs 115 (e.g., m>>2). UEs 115 may each include, for example, a laptop, desktop, or tablet computer; a cellular phone (e.g., a “smart” phone); a Voice over Internet Protocol (VoIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (not shown) may carry, use, administer, and/or operate each UE 115. Each UE 115 may execute at least one client app (client apps 125-1 through 125-m shown, respectively, for UEs 115-1 through 115-m) that may request media from one or more of CDN app servers 120. Client app 125 may include, for example, an audio/video player that plays audio/video media streamed from a CDN app server 120 via CDN 110 and mobile network 105. As an example, FIG. 1 depicts client app 125-1 at UE 115-1 engaging in a streaming media session with CDN app server 120-1, client app 125-2 at UE 115-2 engaging in a streaming media session with CDN app server 120-1, and client app 125-m at UE 115-m engaging in a streaming media session with CDN app server 120-2.

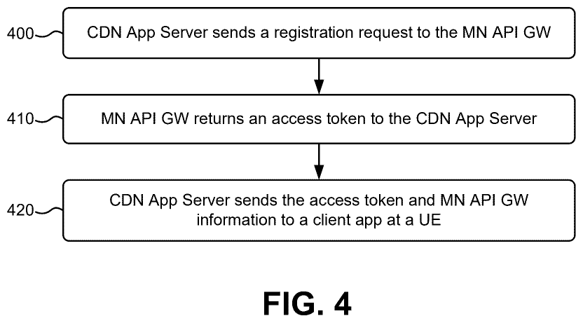

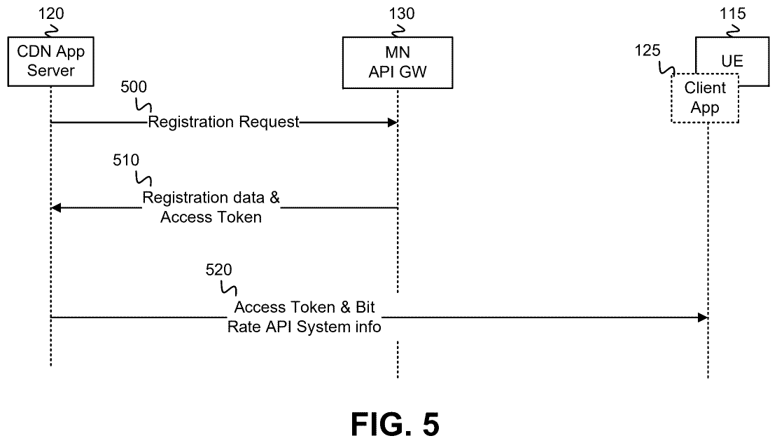

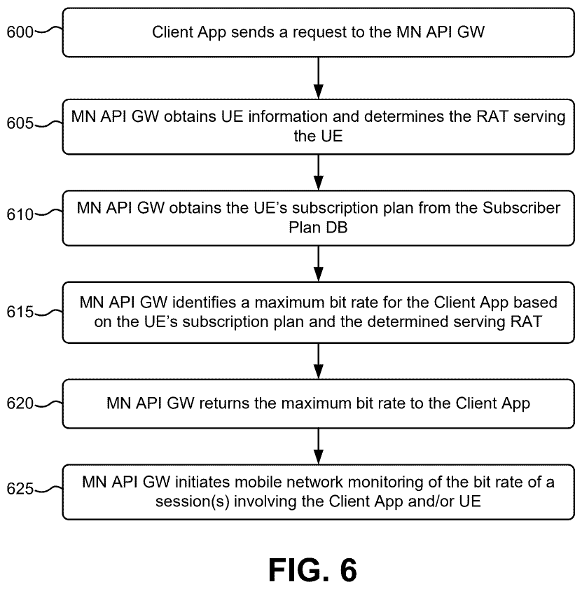

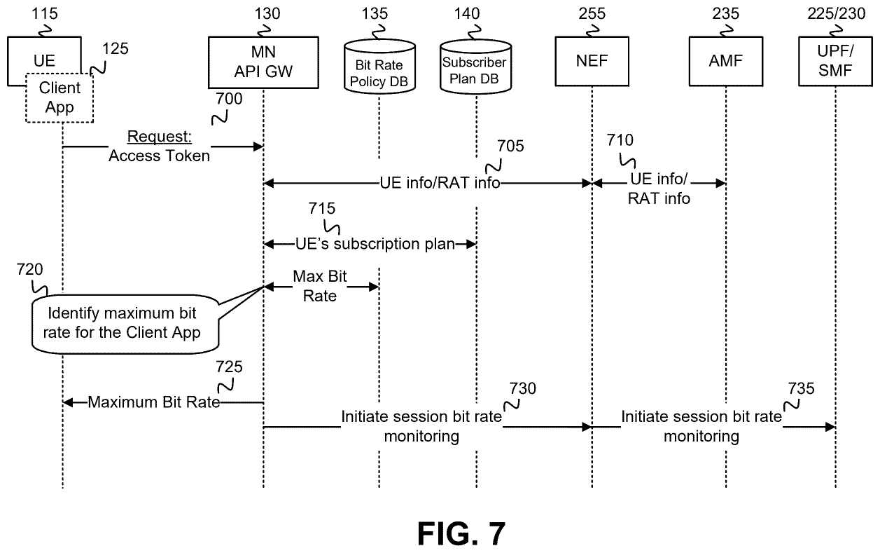

As further shown in FIG. 1, mobile network 105 may include a mobile network (MN) API Gateway (GW) 130, a bit rate policy database (DB) 135, and a subscriber plan DB 140. MN API GW 130 may include a bit rate API system that implements an API for providing maximum bit rates to multiple client applications 125 at UEs 115. MN API GW 130 may access subscriber plan DB 140 to obtain subscriber plan information for a particular UE 115. MN API GW 130 may further obtain device information for the UE 115, and Radio Access Technology (RAT) information that identifies the RAT of mobile network 105 which currently serves the UE 115. MN API GW 130 may then consult bit rate policy DB 135 and use the subscriber plan information and the RAT information to determine and specify a maximum bit rate for the client app 125 at the UE 115. In some implementations, MN API GW 130 may include an overall system that further includes at least two separate network devices: a first of the network devices may implement the API GW and execute the registration and token issuance of FIG. 4, and a second of the network devices may implement the bit rate API system and execute the maximum bit rate identification of FIG. 6. In other implementations, the registration and token issuance of FIG. 4 and the maximum bit rate identification of FIG. 6 may be implemented by a same network device or system. Subscriber plan DB 140 may store and maintain information that details the subscription plans of subscribers associated with each UE 115. Bit rate policy DB 135 may store and maintain policies that relate subscriber device subscription plans and serving RATs to a maximum bit rate for a client app 125 at a UE 115.

The configuration of components of the network environment 100 of FIG. 1 is for illustrative purposes. Other configurations, having a different arrangement than depicted in FIG. 1, may be implemented. Network environment 100 may also include additional, fewer, and/or different components, or networks, than shown in FIG. 1. For example, mobile network 105 may include additional, and/or different, nodes, functions, or devices than those shown in FIG. 1.

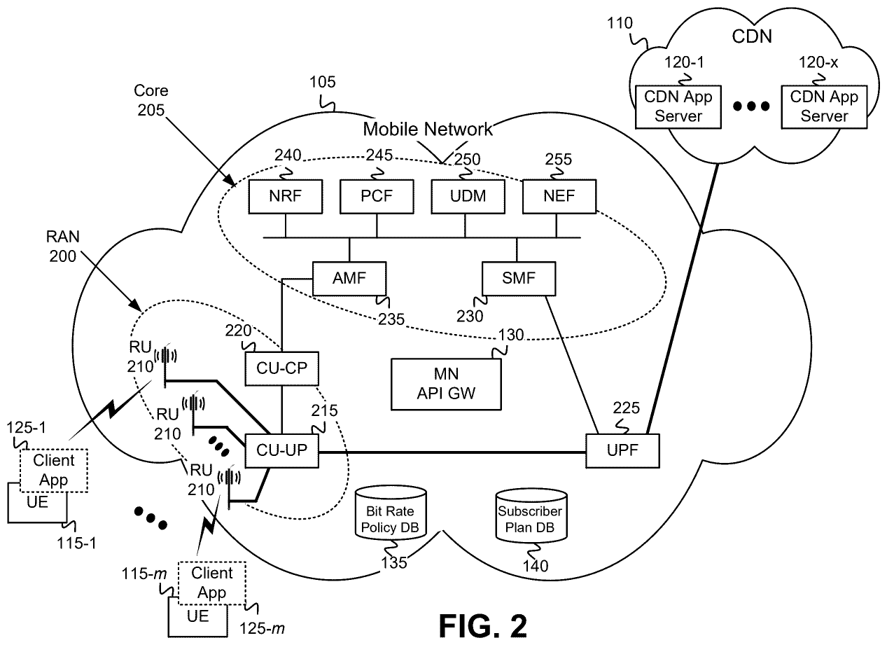

FIG. 2 depicts an example of mobile network 105 and its various interconnections with other nodes, devices, or networks. As shown, mobile network 105 may connect with UEs 115-1 through 115-m and CDN 110. In the example shown, mobile network 105 may include sub-networks, such as a Radio Access Network (RAN) 200 and a core network 205. The radio access equipment of RAN 200 may include multiple Radio Units (RUs) 210, multiple DUs (not shown), at least one Control Unit-User Plane function (CU-UP) 215 and at least one Control Unit-Control Plane (CU-CP) function 220. Additionally, or alternatively, RAN 200 may include non-split or integrated RAN devices, such as a Next Generation NodeB (gNB) or Evolved NodeB (eNB). Only a single one of CU-UP 215 and CU-CP 220 is shown in FIG. 2, however, RAN 200 may include multiple CU-UPs 215 and CU-CPs 220. In some implementations, each CU-UP 215 and CU-CP 220 may be associated with one or more clusters of cells within RAN 200. For example, a particular CU-CP 220 may control and manage the operation of DUs and RUs 210 residing within one or more clusters of cells, and a corresponding CU-UP 215 may manage and handle user plane traffic that originates from, or is destined to, the DUs and RUs residing within the one or more clusters of cells.

CU-UP 215 may interconnect with one or more DUs via fronthaul links or a fronthaul network and may include a logical node that hosts user plane functions, such as, for example, data routing and transport functions. For example, CU-UP 215, among other functions, routes outgoing traffic (e.g., from a UE 115) to a User Plane Function (UPF) 225 and routes incoming traffic to a DU and RU 210 that serve the traffic's destination UE 115. UPF 225 may act as a router and a gateway between mobile network 105 and CDN 110 (or other data network(s)) and may forward session data (e.g., streaming media sessions) between CDN 110 and RAN 200. Though only a single UPF 225 is shown in FIG. 2, mobile network 105 may include multiple UPFs 225 at various locations in mobile network 105.

Each DU includes a logical node that hosts functions associated with the Radio Link Control (RLC) layer, the Medium Access Control (MAC) layer, and the physical layer (PHY). Each DU further performs centralized processing and coordination of one or more RUs 210, handles tasks such as scheduling and overall control of the radio resources, and interfaces with core network functions (NFs) to establish and manage connections with UEs 115 and to facilitate communication between different cells.

RUs 210 may be located at certain geographic positions within mobile network 105, and operate as radio function units that transmit and receive wireless signals (e.g., Radio Frequency (RF) signals) to/from UEs 115. Each of the RUs 210 may include at least one antenna array, transceiver circuitry, and other hardware and software components for enabling the RU 210 to receive data via wireless signals from UEs 115, and to transmit wireless signals to UEs 115. Each RU 210 may connect to a respective DU (not shown) which, in turn, connects to a CU-UP 215 and a CU-CP 220.

CU-CP 220 includes a logical node that hosts Radio Resource Control (RRC), and other control plane, functions (e.g., Service Data Adaptation Protocol (SDAP), Packet Data Convergence Protocol (PDCP)) for the CU-UP 215 and for the DUs and RUs 210 that it controls. RAN 200 may additionally include other nodes, functions, and/or components not shown in FIG. 2.

Core network 205 includes devices or nodes that host and execute network functions (NFs) that operate the mobile network 105 including, among other NFs, mobile network access management, session management, and policy control NFs. In the example mobile network 105 of FIG. 2, core network 205 is shown as including 5G NFs, such as a Session Management Function (SMF) 230, an Access and Mobility Management Function (AMF) 235, a Network Repository Function (NRF) 240, a Policy Control Function (PCF) 245, a Unified Data Management (UDM) function 250, and a Network Exposure Function (NEF) 255. Each of UPF 225, SMF 230, AMF 235, NRF 240, PCF 245, UDM 250, and NEF 255 may be implemented as a Virtual Network Function (VNF) or a Cloud-Native Network Function (CNF) (e.g., at a data center(s)) or as a Physical Network Function (PNF) within mobile network 105.

UPF 225 may act as a router and a gateway between mobile network 105 and CDN 110 and may forward session data between CDN 110 and RAN 200. Though only a single UPF 225 is shown in FIG. 2, mobile network 105 may include multiple UPFs 225 at various locations in mobile network 105. SMF 230 performs session management and selects and controls UPFs 225 for data transfer. AMF 235 performs mobility management for the UEs 115.

NRF 240 operates as a centralized repository of information regarding NFs in mobile network 105. NRF 240 enables NFs (e.g., UPF 225, SMF 230, AMF 235, NRF 240, PCF 245, UDM 250, NEF 255) to register and discover each other via an API. NRF 240 maintains an updated repository of information about the NFs available in mobile network 105, along with information about the services provided by each of the NFs. NRF 240 further enables the NFs to obtain updated status information of other NFs in mobile network 105. NRF 240 may, for example, maintain profiles of available NF instances and their supported services, allow NF instances to discover other NF instances in mobile network 105, and allow NF instances to track the status of other NF instances.

PCF 245 may provide policy rules for control plane functions (e.g., for network slicing, roaming, and/or mobility management) and may access user subscription information for policy decisions. UDM 250 manages data for user access authorization, user registration, and data network profiles. UDM 250 may include, or operate in conjunction with, a User Data Repository (UDR-not shown) which stores user data, such as user/customer/subscriber profile information, user/customer/subscriber authentication information, user/customer-subscribed network slice information, and encryption keys. NEF 255 securely exposes various NF events and capabilities. For example, NEF 255 may expose UE location determining capabilities that enable the identification of the RAT serving a UE 115 at its current location relative to components of RAN 200.

The configuration of network components of the example mobile network 105 of FIG. 2 is for illustrative purposes. Other configurations may be implemented. Therefore, mobile network 105 may include additional, fewer, and/or different components that may be configured in a different arrangement than that depicted in FIG. 2. Mobile network 105 is shown in the example of FIG. 2 as including components associated with a 5G mobile network. In other implementations, however, different types of mobile networks or different mobile network components may alternatively, or additionally, be used, such as, for example, 4G or 6G mobile networks and/or hybrid 4G/5G or 5G/6G mobile networks. Furthermore, core network 205 may include other NFs not shown in FIG. 2. Though only a single instance of each of the core network NFs (e.g., UPF 225, SMF 230, AMF 235, NRF 240, PCF 245, UDM 250, NEF 255) is shown in FIG. 2, mobile network 105 may include multiple instances of each of the NFs. When implemented as VNFs or CNFs, each of the NFs described above may be installed in, and executed by, a network device residing in mobile network 105, or in another network (e.g., in an edge or a far edge network, not shown). A single network device may host and execute one or more of the NFs described above, and mobile network 105 may include at least one network device, or may have multiple (e.g., numerous) network devices that each host and execute one or more of the NFs described above.

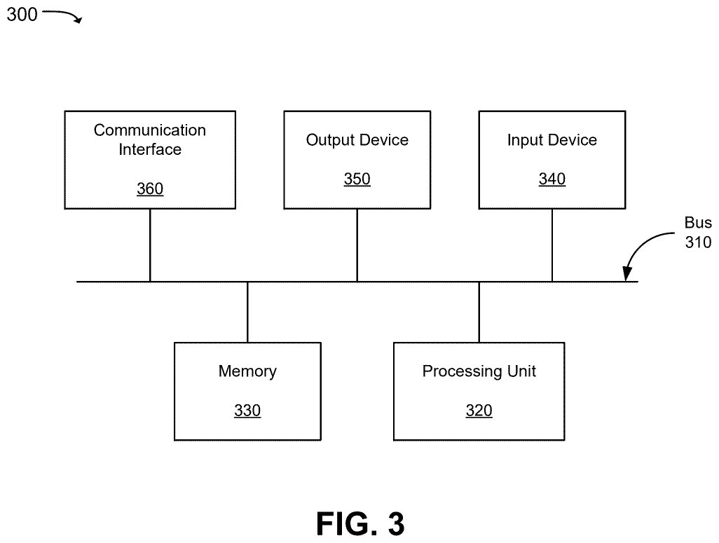

FIG. 3 is a diagram that depicts example components of a network device 300 (referred to herein as a “network device,” a “device,” or a “system”). UEs 115, CDN app servers 120, RUs 210, DUs, CU-UP 215, CU-CP 220, MN API GW 130, bit rate policy DB 135, and subscriber plan DB 140 may each include components that are the same as, or similar to, those of device 300 shown in FIG. 3. Furthermore, each of the NFs in mobile network 105 (e.g., UPF 225, SMF 230 AMF 235, NRF 240, PCF 245, UDM 250, and NEF 255) may be implemented by a device that includes components that are the same as, or similar to, those of network device 300. Some of the NFs of mobile network 105 may be implemented by a same device 300 within mobile network 105, while others of the functions may be implemented by one or more separate devices 300 within mobile network 105.

Device 300 may include a bus 310, a processing unit 320, a memory 330, an input device 340, an output device 350, and a communication interface 360. Bus 310 may include a path that permits communication among the components of device 300. Processing unit 320 may include one or more processors or microprocessors which may interpret and execute instructions, or processing logic. Memory 330 may include one or more memory devices for storing data and instructions. Memory 330 may include a random access memory (RAM) or another type of dynamic storage device that may store information and instructions for execution by processing unit 320, a Read Only Memory (ROM) device or another type of static storage device that may store static information and instructions for use by processing unit 320, and/or a magnetic, optical, or flash memory recording and storage medium. The memory devices of memory 330 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 330 for execution by processing unit 320.

Input device 340 may include one or more mechanisms that permit an operator to input information into device 300, such as, for example, a keypad or a keyboard, a display with a touch sensitive panel, voice recognition and/or biometric mechanisms, etc. Output device 350 may include one or more mechanisms that output information to the operator, including a display, a speaker, etc. Input device 340 and output device 350 may, in some implementations, be implemented as a user interface (UI) that displays UI information and which receives user input via the UI. Communication interface 360 may include a transceiver(s) that enables device 300 to communicate with other devices and/or systems. For example, communication interface 360 may include one or more wireless transceivers (e.g., RF transceivers) for communicating via mobile network 105. In some implementations, communication interface 360 may additionally include one or more wired transceivers for communicating via a data network (e.g., the Internet). In the case of RUs 210 of RAN 200, communication interface 360 may further include one or more antennas or antenna arrays for producing radio frequency (RF) cells or cell sectors.

The configuration of components of network device 300 illustrated in FIG. 3 is for illustrative purposes. Other configurations may be implemented. Therefore, network device 300 may include additional, fewer and/or different components, that may be arranged in a different configuration, than depicted in FIG. 3.

FIG. 4 is a flow diagram of an example process for registering a CDN app server 120 with MN API GW 130. In order for a client app 125 to access MN API GW 130, the client app 125 may need to be issued a valid access token. In the example process of FIG. 4, a CDN app server 120, with which client app 125 may engage in a streaming media session, initiates a registration process with MN API GW 130 and, in response, MN API GW 130 provides an access token to CDN app server 120 that CDN app server 120 may, in turn, issue to client app 125 for use in obtaining a maximum bit rate from MN API GW 130. The example process of FIG. 4 may be implemented by CDN app server 120 in cooperation with MN API GW 130, and is described below with additional reference to the diagram of FIG. 5.

The example process includes CDN app server 120 sending a registration request to MN API GW 130 (block 400). The registration request may include, among other data, an identifier (ID) (e.g., network address, such as an Internet Protocol (IP) address) that uniquely identifies CDN app server 120. FIG. 5 depicts CDN app server 120 sending a Registration Request 500 to MN API GW 130.

MN API GW 130 returns an access token to the registering CDN app server 120 (block 410). The access token may subsequently be used for accessing MN API GW 130. In addition to the access token, MN API GW 130 may return other registration-related data to CDN app server 120. FIG. 5 shows MN API GW 130 returning 510 an access token to the requesting CDN app server 120.

CDN app server 120 sends the received access token and MN API GW information to a client app 125 at a UE 115 (block 420). CDN app server 120 generates a message that includes the access token received from MN API GW 130 in block 410 and further includes MN API GW information, such as, for example, a network address of MN API GW 130. FIG. 5 depicts CDN app server 120 sending a message 520 that includes the access token and MN API GW information that will enable client app 125 at UE 115 to request a maximum bit rate to MN API GW 130.

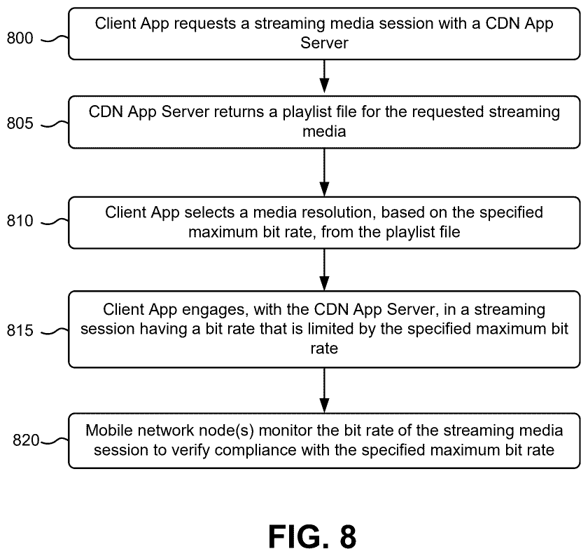

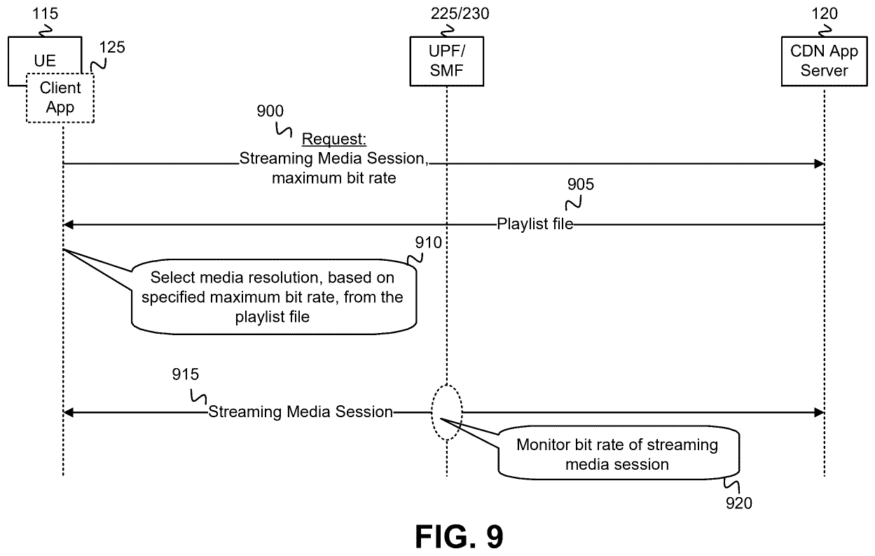

FIG. 6 is a flow diagram of an example process for specifying a maximum bit rate, to be issued to a client app 125 at a UE 115, for subsequent use in a media streaming session(s), as described further with respect to the example process of FIG. 8 below. The example process of FIG. 6 may be implemented by a client app 125 in cooperation with MN API GW 130 and is described with additional reference to the diagram of FIG. 7.

The example process includes a client app 125 sending a request to MN API GW 130 (block 600). In one implementation, the request may merely include a notification that notifies MN API GW 130 of the existence of client app 125 (e.g., subsequent to installation at UE 115) and may include data that identifies client app 125 and/or UE at which the client app 125 is executing. For example, the notification may include a unique identifier (ID) that identifies the client app 125 or a combination of identifiers (e.g., a unique ID of client app 125 and a unique ID of UE 115). In this notification implementation, the notification may additionally include the access token previously received from CDN app server 120 (e.g., in block 420 of FIG. 4). In another implementation, the request may include an explicit request from the client app 125 to receive a maximum bit rate for the client app 125 or the UE 115. In this explicit request implementation, the request may include an access token previously received from CDN app server 120 (e.g., in block 420 of FIG. 4). FIG. 7 depicts client app 125 at UE 115 sending a request message 700, that includes an access token, to MN API GW 130.

MN API GW 130 obtains UE information and determines the RAT serving the UE 115 (block 605). MN API GW 130 may obtain the device information for the UE 115, and the RAT type serving the UE 115, via NEF 255 and AMF 235 (or a Location Management Function (LMF) in mobile network 105). The RAT serving the UE 115 may include, for example, an LTE RAT, a 5G RAT, a C-band RAT, or a millimeter (mm) wave RAT. Other, different types of RATs may be determined as serving UE 115 depending on the particular type and configuration of the RAN 200 of the mobile network 105. FIG. 7 shows MN API GW 130 obtaining UE and RAT information via a NEF 255 and an AMF 235.

MN API GW 130 obtains the UE 115's subscription plan from subscriber plan DB 140 (block 610). MN API GW 130 may retrieve the UE 115's subscription plan from subscriber plan DB 140 based on, for example, an identifier associated with the UE 115 (e.g., International Mobile Equipment Identifier (IMEI), International Mobile Subscriber Identifier (IMSI), Subscription Permanent ID (SUPI), or the like). The subscription plan may include information regarding various aspects of the subscriber's subscribed level of service. Multiple different subscription plans may specify service types and/or service quality parameters associated with each respective level of service. The service types may include, for example, mobile service or fixed wireless access (FWA) service and may additionally include RAT service types for each subscription plan (e.g., LTE, 5G, C-band, mmwave). Service quality parameters associated with each different subscription plan may include particular levels of bandwidth, throughput, latency, jitter, and/or error rate. As shown in FIG. 7, MN API GW 130 obtains the UE 115's subscription plan from subscriber plan DB 140.

MN API GW 130 identifies a maximum bit rate for the client app 125 based on the UE 115's subscription plan and the determined serving RAT (block 615), and returns the identified maximum bit rate to the client app 125 (block 620). MN API GW 130 may consult bit rate policy DB 135, using the UE 115's subscription plan and the determined serving RAT, to identify the maximum bit rate for the client app 125. Bit rate policy DB 135, for example, may include policies that relate particular subscription plans and serving RATs to a maximum bit rate. As one example, a first bit rate policy stored in bit rate policy DB 135 may include the following: if subscription plan=standard_high and RAT type=LTE, then maximum bit rate=MBR_1 Megabits per second (Mbps). As another example, a second bit rate policy stored in bit rate policy DB 135 may include the following: if subscription plan=premium_low and RAT type=C-band, then maximum bit rate=MBR_2 Mbps. Multiple different policy rules stored in bit rate policy DB 135 may relate different combinations of subscription plans and serving RATs to different maximum bit rates.

In the case of client app 125 sending a notification in block 600, MN API GW 130 may perform blocks 605, 610, and 615 and may “push” the identified maximum bit rate to the client app 125 at some point in time subsequent to receiving the notification. In the case of client app 125 sending an express maximum bit rate request in block 600 to “pull” the identified maximum bit rate, MN API GW 130 may perform blocks 605, 610, and 615 directly after receiving the maximum bit rate request. FIG. 7 shows MN API GW 130 identifying 720, by consulting bit rate policy DB 135, a maximum bit rate for the client app 125 of UE 115, and returning a message 725 to client app 125 at UE 115 that includes the identified maximum bit rate 725 for the UE 115.

MN API GW 130 initiates mobile network monitoring of the bit rate of a session(s) involving the client app 125 and/or the UE 115 (block 625). The mobile network monitoring of the bit rate of a session(s) involving the client app 125 at the UE 115 is described further at block 820 of FIG. 8 below. FIG. 7 depicts MN API GW 130 initiating 730/735 session bit rate monitoring via NEF 255 and UPF/SMF 225/230.

Certain blocks of the example process of FIG. 6 may be repeated based on dynamic RAT changes that occur when mobile network 105 is providing wireless service to the UE 115. A RAT change may occur, for example, based on the UE 115 moving between different mobile network areas (e.g., different cells, or different clusters of cells) that each use a different RAT. As another example, a RAT change may occur in a same mobile network area (e.g., a same cell or cell cluster) when that mobile network area includes two or more different RATs which provide service to a same geographic area, and service to the UE 115 is switched from a first RAT to a second RAT within that same mobile network area. In some implementations, after execution of the blocks of FIG. 6, blocks 605, 610, 615, and 620 may be repeated based on, for example, the occurrence of a RAT change such that an updated maximum bit rate may be returned, by MN API GW 130, to the client app 125 at the UE 115.

FIG. 8 is a flow diagram of an example process for engaging in a streaming session, by a client app 125 with a CDN app server 120, in which the specified maximum bit rate may be used to limit the bit rate of the streaming session. The example process of FIG. 8 may be implemented by a client app 125 in cooperation with a CDN app server 120 and one or more other nodes/devices of mobile network 105. The process of FIG. 8 is described with additional reference to the diagram of FIG. 9.

The example process includes a client app 125 requesting a streaming media session with a CDN app server 120 (block 800), and CDN app server 120, upon receipt of the streaming media session request, returning a playlist file for the requested streaming media (block 805). The request for the streaming media session, sent by client app 125, may include the specified maximum bit rate received from MN API GW 130 in block 620 of FIG. 6, and may also include an identifier for the particular media being requested by the client app 125. CDN app server 120 may use the received maximum bit rate for setting limits on the bit rate of data sent from CDN app server 120 to the requesting client app 125 for the streaming media session. Additionally, client app 125 may use the maximum bit rate to set limits on the bit rate of data sent from client app 125 to CDN app server 120 for the streaming media session. FIG. 9 shows client app 125 at UE 115 sending a Request 900, via UPF/SMF 225/230 for a streaming media session to CDN app server 120 and, in response, CDN app server 120 returning a playlist file 905 for the requested media via UPF/SMF 225/230.

Client app 125 selects a media resolution, based on the specified maximum bit rate, from the playlist file (block 810), and engages, with the CDN app server 120, in a streaming media session having a bit rate that is limited by the specified maximum bit rate (block 815). The media resolution in the case of video media may include, for example, a width x height pixel display resolution. The level of the specified maximum bit rate impacts the media resolution that client app 125 chooses for the streaming media session. For example, a higher maximum bit rate enables the selection of a higher media resolution, and a lower maximum bit rate causes selection of a lower media resolution. The specified maximum bit rate may, for example, have been received from MN API GW 130 in block 620 of FIG. 6. The streaming media session may include, for example, an HLS or DASH audio/video streaming media session. During the streaming media session between CDN app server 120 and client app 125, CDN app server 120 and/or client app 125 may monitor and control the bit rate of the streaming session to limit the bit rate to the previously specified maximum bit rate. FIG. 9 depicts client app 125 at UE 115 selecting 910 a media resolution from the playlist file for the streaming media session based on the specified maximum bit rate.

A node(s) of mobile network 105 monitors the bit rate of the streaming media session to verify compliance with the specified maximum bit rate (block 820). For example, SMF 230 and/or UPF 225 may monitor data of the streaming media session transiting the User Plane of mobile network 105 (e.g., at UPF 225) to determine whether the bit rate of the session is maintained at a level less than a threshold that equals the specified maximum bit rate. Another node(s), other than SMF 230 and/or UPF 225 may monitor the bit rate of the streaming media session as the session data transits mobile network 105.

The blocks of the example process of FIG. 8 may be repeated for each client app 125 that requests a streaming media session with a CDN app server 120. In some implementations, if two or more client apps 125 are executing on a same UE 115, then the specified maximum bit rate may be applied to the aggregate of the two streaming media sessions. For example, if client_app_1 and client_app_2 executing on a same UE 115 are simultaneously engaging in streaming media sessions with one or more CDN app servers 120 (e.g., streaming_session_1 at bit_rate_1, and streaming_session_2 at bit_rate_2), then the sum of bit_rate_1 and bit_rate_2 should be less than or equal to the specified maximum bit rate (i.e., bit_rate_1 30 bit_rate_2≤specified maximum bit rate).

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 4, 6, and 8, and sequences of operations, messages, and/or data flows with respect to FIGS. 5, 7, and 9, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 320) of a device. A non-transitory storage medium includes one or more of the storage mediums described in relation to memory 330. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network device from a first client application executing at a first user equipment device (UE), a first notification;
obtaining, by the network device based on the first notification, a first subscription plan associated with the first UE;
determining, by the network device, a first Radio Access Technology (RAT) of a mobile network that is currently serving the first UE;
identifying, by the network device, a first maximum bit rate for the first client application based on the first subscription plan and the determined first RAT; and
sending, by the network device, the identified first maximum bit rate to the first client application for use in limiting a bit rate of one or more first data sessions involving the first client application that transit the mobile network.

2. The method of claim 1, wherein the network device implements an Application Programming Interface (API) for providing maximum bit rates to multiple client applications that include the first client application.

3. The method of claim 1, wherein the first notification notifies the network device of an identity of the first client application.

4. The method of claim 1, wherein the first notification comprises a request from the first client application for a maximum bit rate for setting limits on the one or more first data sessions.

5. The method of claim 1, further comprising:
initiating, by the network device, mobile network monitoring of an actual bit rate of the one or more first data sessions involving the first client application to verify compliance with the identified first maximum bit rate.

6. The method of claim 1, wherein receiving the first notification occurs prior to a start of the one or more first data sessions.

7. The method of claim 1, further comprising:
determining, by the network device, a change in RAT currently serving the first UE from the first RAT to a second RAT;
identifying, by the network device, a second maximum bit rate for the first client application based on the first subscription plan and the second RAT; and
sending, by the network device, the identified second maximum bit rate to the first client application for use in limiting a bit rate of the one or more first data sessions.

8. The method of claim 1, further comprising:
receiving, by the network device from a second client application executing at a second UE, a second notification;
obtaining, by the network device based on the second notification, a second subscription plan associated with the second UE;
determining, by the network device, a second RAT of the mobile network that is currently serving the second UE;
identifying, by the network device, a second maximum bit rate for the second client application based on the second subscription plan and the determined second RAT; and
sending, by the network device, the identified second maximum bit rate to the second client application for use in limiting a bit rate of one or more second data sessions involving the second client application that transit the mobile network.

9. A network device, comprising:
at least one communication interface configured to communicate via a mobile network; and
at least one processor configured to:
receive, from a first client application executing at a first user equipment device (UE), a first notification,
obtain, based on the first notification, a first subscription plan associated with the first UE,
determine a first Radio Access Technology (RAT) of the mobile network that is currently serving the first UE,
identify a first maximum bit rate for the first client application based on the first subscription plan and the determined first RAT; and
send the identified first maximum bit rate to the first client application for use in limiting a bit rate of one or more first data sessions involving the first client application that transit the mobile network.

10. The network device of claim 9, wherein network device implements an Application Programming Interface (API) for providing maximum bit rates to multiple client applications that include the first client application.

11. The network device of claim 9, wherein the first notification notifies the network device of an identity of the first client application.

12. The network device of claim 9, wherein the first notification comprises a request from the first client application for a maximum bit rate for setting limits on the one or more first data sessions.

13. The network device of claim 9, wherein the at least one processor is further configured to:
initiate, via the at least one communication interface, mobile network monitoring of an actual bit rate of the one or more first data sessions involving the first client application to verify compliance with the identified first maximum bit rate.

14. The network device of claim 9, wherein receiving the first notification occurs prior to a start of the one or more first data sessions.

15. The network device of claim 9, wherein the at least one processor is further configured to:
determine a change in RAT currently serving the first UE from the first RAT to a second RAT,
identify a second maximum bit rate for the first client application based on the first subscription plan and the second RAT, and
send the identified second maximum bit rate to the first client application for use in limiting a bit rate of the one or more first data sessions.

16. The network device of claim 9, wherein the at least one processor is further configured to:
receive, from a second client application executing at a second UE, a second notification,
obtain, based on the second notification, a second subscription plan associated with the second UE,
determine a second RAT of the mobile network that is currently serving the second UE,
identify a second maximum bit rate for the second client application based on the second subscription plan and the determined second RAT, and
send the identified second maximum bit rate to the second client application for use in limiting a bit rate of one or more second data sessions involving the second client application that transit the mobile network.

17. A non-transitory storage medium storing instructions executable by a network device, wherein execution of the instructions causes the network device to:
receive, from a first client application executing at a first user equipment device (UE), a first notification;
obtain, based on the first notification, a first subscription plan associated with the first UE;
determine a first Radio Access Technology (RAT) of a mobile network that is currently serving the first UE;
identify a first maximum bit rate for the first client application based on the first subscription plan and the determined first RAT; and
send the identified first maximum bit rate to the first client application for use in limiting a bit rate of one or more first data sessions involving the first client application that transit the mobile network.

18. The non-transitory storage medium of claim 17, wherein execution of the instructions further causes the network device to:
initiate mobile network monitoring of an actual bit rate of the one or more first data sessions involving the first client application to verify compliance with the identified first maximum bit rate.

19. The non-transitory storage medium of claim 17, wherein receiving the first notification occurs prior to a start of the one or more first data sessions.

20. The non-transitory storage medium of claim 17, wherein execution of the instructions further causes the network device to:
determine a change in RAT currently serving the first UE from the first RAT to a second RAT;
identify a second maximum bit rate for the first client application based on the first subscription plan and the second RAT; and
send the identified second maximum bit rate to the first client application for use in limiting a bit rate of the one or more first data sessions.
